(19) United States
(12) Patent Application Publication
(10) Pub. No.: US 2020/0226953 A1
(43) Pub. Date: Jul. 16, 2020

(54) SYSTEM AND METHOD FOR FACILITATING MASKING IN A COMMUNICATION SESSION

(71) Applicant: Avaya Inc., Santa Clara, CA (US)

(72) Inventors: Avinash Anand, Pune (IN); Divakar Ray, Pune (IN); Arjunsingh Rawat, Pune (IN)

(21) Appl. No.: 16/245,713

(22) Filed: Jan. 11, 2019

(51) Int. Cl. G09C 5/00; H04N 7/15; G06K 9/32; G06K 9/00

(52) U.S. Cl. CPC G09C 5/00; G06K 9/00221; G06K 9/3241; H04N 7/15

(57) ABSTRACT

A request to mask an object in a transmitted media stream of a communication session is received. For example, a request to mask a portion of an image, such as a license plate in an image of an automobile is received from a user via a toolbar. A determination is made that a media stream with the object is going to be transmitted in the communication session. For example, the image object is going to be transmitted in a co-browsing session. The object is masked from the media stream of the communication session. The media stream with the masked object is then transmitted in the communication session. The masking prevents the other users in the communication session from seeing the masked object. In one embodiment, the user may select individual users in the communication session that will receive the masked object.

### FIELD

The disclosure relates generally to electronic communication sessions and particularly to masking of information sent in the electronic communication sessions.

### BACKGROUND

The use of interactive collaboration sessions is well known today. One of the problems with the current interactive collaborative solutions is that a user may inadvertently display sensitive information to other users when interacting or sharing a view of their screen during the collaborative session. One way to prevent data from leaving a user's browser in a co-browsing session is discussed in U.S. Pat. No. 9,736,212. This patent teaches that a user can define a list of masked fields for a co-browsing session that are prevented from leaving a visitor's browser.

### SUMMARY

These and other needs are addressed by the various embodiments and configurations of the present disclosure. A request to mask an object in a transmitted media stream of a communication session is received. For example, a request to mask a portion of an image, such as a license plate in an image of an automobile is received from a user via a toolbar. A determination is made that a media stream with the object is going to be transmitted in the communication session. For example, the image object is going to be transmitted in a co-browsing session. The object is masked from the media stream of the communication session. The media stream with the masked object is then transmitted in the communication session. The masking prevents the other users in the communication session from seeing the masked object. In one embodiment, the user may select individual users in the communication session that will receive the masked object.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “co-browsing session” as described herein and in the claims is where a user displays a view of their browser during a communication session.”

The term “communication session” as described herein an in the claims is a video, multimedia, co-browsing, virtual reality, and/or the like communication session. In other words, any type of communication session that uses video.

The term “object” as described herein and in the claims may include any graphical object (or a portion of a graphical object), such as an image (e.g., an image of a license plate, an image of a car, an image of a credit card, an image of a person, and/or the like), a button, a number, a menu, a text field, an a tool bar, a check box, a user selected image or field, a window, an icon, a message box, a user name, and/or the like.

In addition, an “object” as described herein and in the claims may be an audio object or a portion of an audio object, such as, a .wav file, an MP3 file, a spoken word, phrase, sentence, etc. in an audio file, an MPEG file, a sound clip, and/or the like. For example, in a co-browsing session, a slide presentation may play a .wav file to the other participants in the co-browsing session.

Moreover, an “object” as described herein an in the claims may include a vibration object. For example, in a co-browsing session, a multi-media presentation may cause vibrators in communication devices of other participants to vibrate (e.g., in a specific pattern). For example, a message may be sent to vibrate or programming code (e.g., JavaScript) code) of a view of a browser may vibrate a vibrator when the code in the browser is transmitted to another user communication devices.

The terms “mask,” “masked,” “masking” or any variant thereof that is used herein and in the claims in regard to an object may comprise deleting an object, obfuscating an object, changing an object, substituting one object for another (e.g., changing a first number to a second number), blurring an object, changing one or more colors of an object, blacking out an area, covering an area, not playing an object (e.g., an animation or audio file), muting a portion of an audio clip, changing what is said in all of an audio clip or portion of an audio clip, not vibrating a vibrator, changing a vibration pattern, and/or the like. In addition, only a portion of an object may be masked. For example, only a portion of the text object in an image may be masked.

As defined herein an in the claims, the term “code” refers to programming code (e.g., programmed by a user in a programming language, such as JavaScript) that used is interpreted for displaying in a browser/display.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for facilitating object masking in a peer-to-peer communication session.

FIG. 2 is a block diagram of a second illustrative system for facilitating object masking using a communication server.

FIG. 3 is a diagram of an exemplary view of a presentation where specific object(s) have been masked by a user.

FIG. 4 is a flow diagram of a process for masking object(s) that are transmitted in a communication session.

FIG. 5 is a flow diagram of a process for determining how object(s) are masked in a communication session.

FIG. 6 is a flow diagram of a process for facilitating object masking in a communication session.

### DETAILED DESCRIPTION

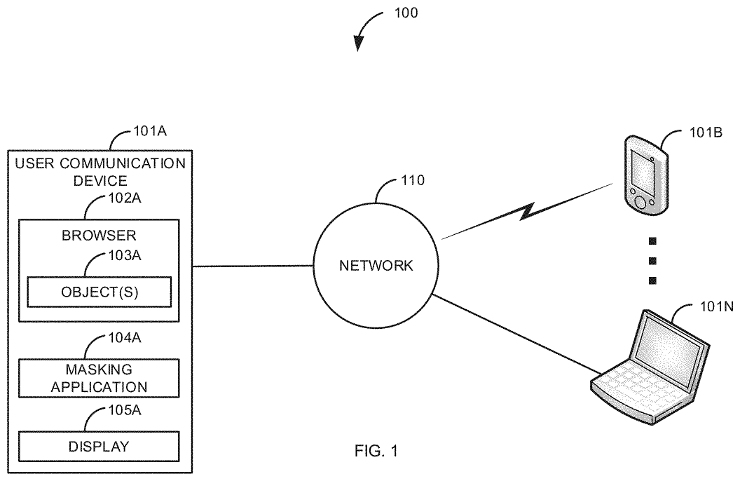

FIG. 1 is a block diagram of a first illustrative system 100 for facilitating object 103 masking in a peer-to-peer communication session. The first illustrative system 100 comprises user communication devices 101A-101N and a network 110.

The user communication devices 101A-101N can be or may include any user communication device 101 that can communicate on the network 110, such as a Personal Computer (PC), a telephone, a user audio/video system, a cellular telephone, a Personal Digital Assistant (PDA), a tablet device, a notebook device, a smartphone, and/or the like. The user communication devices 101A-101N are devices where a communication sessions ends. The user communication devices 101A-101N are not network elements that facilitate and/or relay a communication session in the network, such as a communication manager 221 or router. As shown in FIG. 1, any number of user communication devices 101A-101N may be connected to the network 110.

The user communication device 101A comprises a browser 102A, a masking application 104A, and a display 105A. The browser 102A can be or may include any browser 102 that can be used to display web pages, such a Google Chrome™, Internet Explorer™, Safari™, Opera™, Firefox™ and/or the like.

The browser 102A further comprises one or more objects 103A. The one or more objects 103A in the browser 102A may be user interface elements, videos, images, audio files/information, vibration objects, and/or the like. Although not shown in FIG. 1, the object(s) 103A may reside outside the browser 102A.

The masking application 104A can be or may include any firmware/software that can be used to mask object(s) 103 that are transmitted in a communication session. The masking application 104A can be used to mask any kind of object(s) 103A that are transmitted in the communication session. In one embodiment the objects 103A may reside outside of the browser 102A. For example, a screen view of a PowerPoint® presentation may be provided in the communication session that includes various video, audio, and/or vibration objects 103A. The masking application 104A is used to mask objects 103 in a peer-to-peer communication session. In one embodiment, the masking application 104A may be part of a web page that is downloaded and run in the browser 102A.

The display 105A can be or may include any hardware device that can display information in a communication session, such as, a plasma display, a Light Emitting Diode (LED) display, a Cathode Ray Tube (CRT), a liquid crystal display, a lamp, and/or the like.

Although not shown for convenience, the user communication devices 101B-101N may also comprise all (or a portion) the elements 102-105. For example, the user communication device 102B may a comprise browser 102B, object(s) 103B, a masking application 104B, and a display 105B.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), Integrated Services Digital Network (ISDN), video protocols, Instant Messaging (IM) protocols, and/or the like. Thus, the network 110 is an electronic communication network configured to carry messages via packets and/or circuit switched communications.

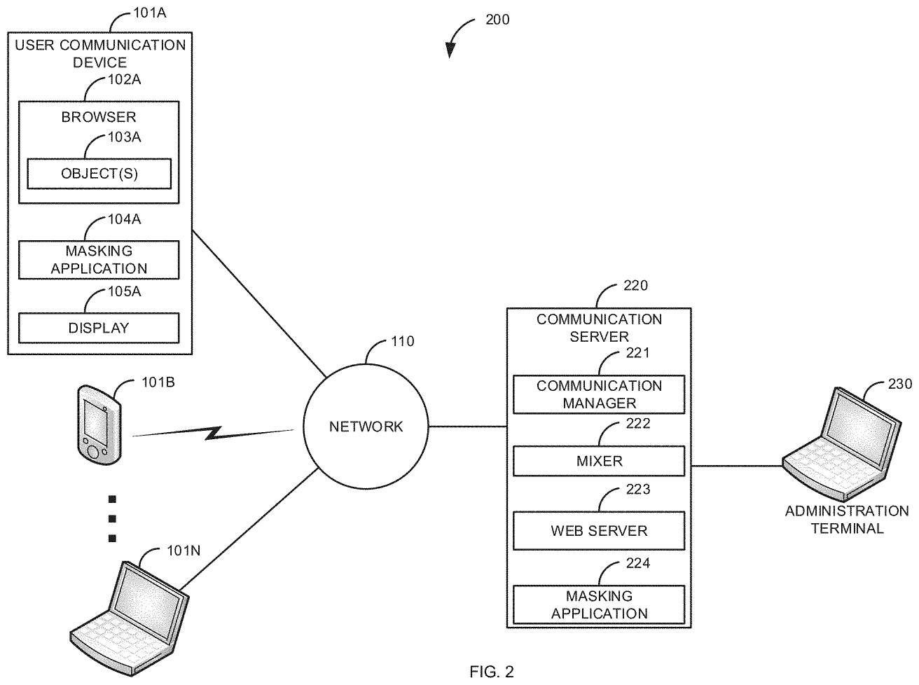

FIG. 2 is a block diagram of a second illustrative system 200 for facilitating object masking using a communication server 220. The second illustrative system 200 comprises the user communication devices 101A-101N, the network 110, the communication server 220 and an administration terminal 230.

The communication server 220 can be or may include any hardware system coupled with firmware/software that can facilitate a communication session between two or more of the user communication devices 101A-101N. For example, the communication server 220 may be a Private Branch Exchange (PBX), a video conferencing system, a session manager, a switch, a conferencing bridge, and/or the like. The communication server 220 comprises a communication manager 221, a mixer 222, a web server 223, and a masking application 224.

The communication manager 221 can be or may include any hardware coupled with firmware/software that can manage and route communication sessions on the network 110, such as a PBX, a session manager, a router, a conference bridge, a proxy server, and/or the like.

The mixer 222 can be or may include any hardware coupled with firmware/software that can mix video/audio streams (a media stream) in a communication session. For example, the mixer 222 can mix audio/video streams for an interactive co-browsing communication session as is well known in the industry.

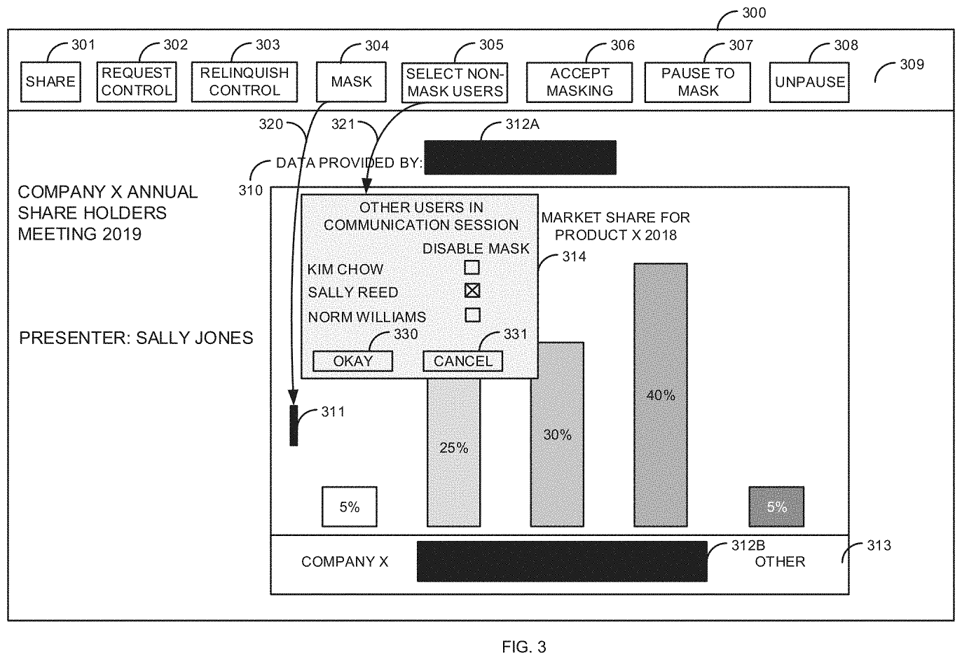

The web server 223 can be or may include any type of web server, such as Apache™, IIS™, nginx™, Google Web Server™, and/or the like. The web server 223 may provide a web page that the user navigates to, which initiates a co-browsing session. The web server 223 may provide additional information, such as a toolbar (e.g., similar to the tool bar shown 309 at the top of the window 300 in FIG. 3).

The masking application 224 is used to provide a centralized masking service for a communication session. As shown in FIG. 2, the masking application 224 may work in conjunction with the masking application 104 in one or more of the user communication devices 101. For example, part of the masking application 104 may be provided by the web server 223. In one embodiment, the masking application 224 is solely in the communication server 220 (i.e., there are no masking applications 104 in the user communication devices 101A-101N).

The administration terminal 230 can be any user communication device 101 that allows an administrator to administer the communication server 220. The administrator may also define object(s) 103 that are masked in the communication session using the administration terminal 230.

FIG. 3 is a diagram of an exemplary view of a presentation where specific objects 103 have been masked by a user. FIG. 3 shows a window 300 that is displayed in the display 105. The window 300 may be: displayed by an application (e.g., a slide in a slide presentation (e.g., by PowerPoint™)), displayed in a browser 102 (e.g., a displayed web page), a view of a camera in a video conference, and/or the like. The process described in FIGS. 3-6 are controlled by the masking application 104 and/or 224.

The window 300 comprises a share button 301, a request control button 302, a relinquish control button 303, a mask button 304, a select non-mask users button 305, an accept masking button 306, a pause to mask button 307, an unpause button 308, a toolbar 309 (that includes the elements 301-308), a data provided text field 310, a masking cursor 311, masked areas 312A-312B, a company text field 313, and a disable mask window 314. The window 300 can display any type of visual information that may in turn be transmitted to another user communication device 101.

In a communication session, (either peer-to-peer (FIG. 1) or communication server 220 based (FIG. 2)) one user at a time may be in control. For example, a user at the user communication device 101A may initially be in control of the communication session. The user can then select the share button 301 to share what is displayed in the window 300 with the other users in the communication session. Another user (e.g., a user at the user communication device 101B) may then request control by selecting the request control button 302 (using a similar window 300). This causes a relinquish control message to be sent and displayed on the user communication device 101A. The user of the user communication device 101A the selects the relinquish control button 303. This causes a message to be displayed on the user communication device 101B that the user of the user communication device 101B is now in control. The user of the user communication device 101B can then select the share button 301 to display the window 300 to the other users in the communication session.

Before sharing the window 300, the user may want to mask out specific object(s) 103 (or portions of object(s) 103) before sharing the window 300 to the other users in the communication session. For example, the user may want to mask out sensitive information that he/she does not want to the other users to see. To do this, the user selects the mask button 304. This causes the masking cursor 311 to appear as shown in step 320. Using the masking cursor 311, the user can click on a mouse button (or use their finger if there is a touch screen) and slide the masking cursor 311 over the masked area(s) 312 the user wants masked out. For example, as shown in FIG. 3, the user has black out the masked areas 312A-312B using the masking cursor 311. The masked area 312A masks out a name of a person or company who provided the data shown in the data provided text field 310. The masked area 312B masks out three of the four company names who have market share for Product X in 2018 (part of the company text field 313). The user then selects the accept masking button 306 to accept masking of the masked areas 312A-312B. The user can then select share button 301 to then transmit, via a media stream, the window 300 to the other users who are participating in the communication session.

Before sharing the window 300, the user may want to selectively share what is masked versus what is not masked to specific users who are in the communication session. To do this, the user selects the select non-mask users button 305. This results in the disable mask window 314 being shown in step 321. The disable mask window 314 shows the other users who are in the communication session. In this example, the disable mask window 314 shows that the other users are: Kim Chow, Sally Reed, and Norm Williams. The user can then select a check-box to disable the mask for an individual user. For example, as shown, the check-box for the user Sally Reed has been checked. The user can then select the okay button 330 to accept the disable mask or select the cancel button 331 to cancel the selections in the disable mask window 314.

The user may want to change what is in the window 300 that is transmitted to the other users in the communication session. For example, the user may want to switch to a new slide. Before switching slides/what is displayed, the user may select the pause to mask button 307. The pause to mask button 307 causes the current display to be sent (the display remains static) while the user changes what is being shown in the window 300. For example, the user may want to change to a new slide in the presentation and mask new information. After selecting the pause to mask button 307, the user can change what is shown in the window 300. The user can the use the masking cursor 311 (similar as described above) to mask new objects 103 that are displayed in the window 300, click on the accept masking button 306, and select the unpause button 308 to transmit the new contents of the window 300 to the other users in the communication session with the newly masked objects 103.

In one embodiment, if the contents of the window 300 changes, the masking application 104/224 may automatically detect the change and require the user to have to select the share button 301 for each change in the window 300. For example, once the user initially selects the share button 301, the share button is disabled. If the masking application 104/224 detects that the contents of the window 300 has changed (e.g., based on defined rules), the transmitted window 300 remains the same as before the change and the share button is enabled. The user can then mask objects 103 as necessary and then select the share button 301 again to share the changed window 300.

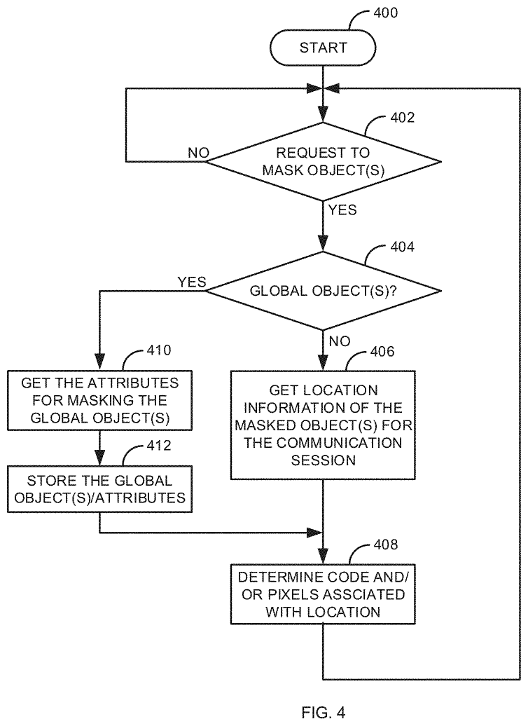

FIG. 4 is a flow diagram of a process for masking object(s) 103 that are transmitted in a communication session. Illustratively, the user communication devices 101A-101N, the browser 102A, the objects 103A, the masking application 104A, the display 105, the communication server 220, the communication manager 221, the mixer 222, the web server 223, the masking application 224, and the administration terminal 230 are stored-program-controlled entities, such as a computer or microprocessor, which performs the method of FIGS. 3-6 and the processes described herein by executing program instructions stored in a computer readable storage medium, such as a memory (i.e., a computer memory, a hard disk, and/or the like). Although the methods described in FIGS. 3-6 are shown in a specific order, one of skill in the art would recognize that the steps in FIGS. 3-6 may be implemented in different orders and/or be implemented in a multi-threaded environment. Moreover, various steps may be omitted or added based on implementation.

The process of FIG. 4 may occur before a communication session is initiated and/or during an active communication session. The process starts in step 400. The masking application 104/224 determines if there is a request to mask object(s) 103 in step 402. A request to mask object(s) 103 may occur in various ways. For example, the request to mask object(s) 103 may work in the manner described in FIG. 3. Alternatively, or in addition, a user from the administration terminal 230 may define the object(s) 103/object type(s) (e.g., a group of objects 103 of a particular type) that are to be masked. If there is not a request to mask object(s) 103 in step 402, the process of step 402 repeats.

Otherwise, if there is a request to mask object(s) 103 in step 402, the masking application 104/224 determines if the request to mask object(s) 103 is for global object(s) 103 in step 404. A global object 103 is an object 103 that is globally applied to all communication sessions (or a specific group of communication sessions). An administrator may use the administration terminal 230 to define global object(s) 103 (using associated attributes) that are to be masked. For example, the administrator may define, prior to a communication session being established, that an image object, such as a license plate within an image. A global object 103 may be masked based on other attributes, such as, based on who is in the communication session, based on other fields that are displayed, based on a location of a user communication device 101 (e.g., in a public place), based on facial recognition, based on voice recognition, based on a biometric, based on the type of communication session, based on a displayed document or content of a displayed document, based on text of an email, and/or the like. For example, based on a database of pictures of user's faces, the masking application 104/224 can look up a user's face (e.g., a minor) and compare it to a face that is displayed in the communication session. If there is a match, the person's face is masked in all communication sessions or specific communication sessions.

A global object 103 (or any object 103) may be masked based on a relative location. For example, a license plate (an element of an object 103 (a car)) may be masked relative to a car window (another element of the car) of a specific model of car. The relative relationship may vary based on a different model of a car.

If the object 103 is a global object 103 in step 404, the masking application 104/224 gets the attributes for masking the global object(s) 103 in step 410. The masking application 104/224 stores the global objects 103/attributes for application to the communication sessions in step 412. The process then goes to step 408.

Otherwise, if the object 103 is not a global object 103 (e.g., as described in FIG. 3 that is for an individual communication session) in step 408, the masking application 104/224 gets location information of the masked objects 103 (e.g., in the display 105) for the communication session in step 406. For example, the masking application 104/224 gets the location/size (e.g., specific pixels using X/Y coordinates) of the masked areas 312A-312B in step 406. The masking application 104/224 determines, in step 408, the code (e.g., lines in the JavaScript/DOM code) and/or pixels associated with the location in step 408. The process then goes back to step 402.

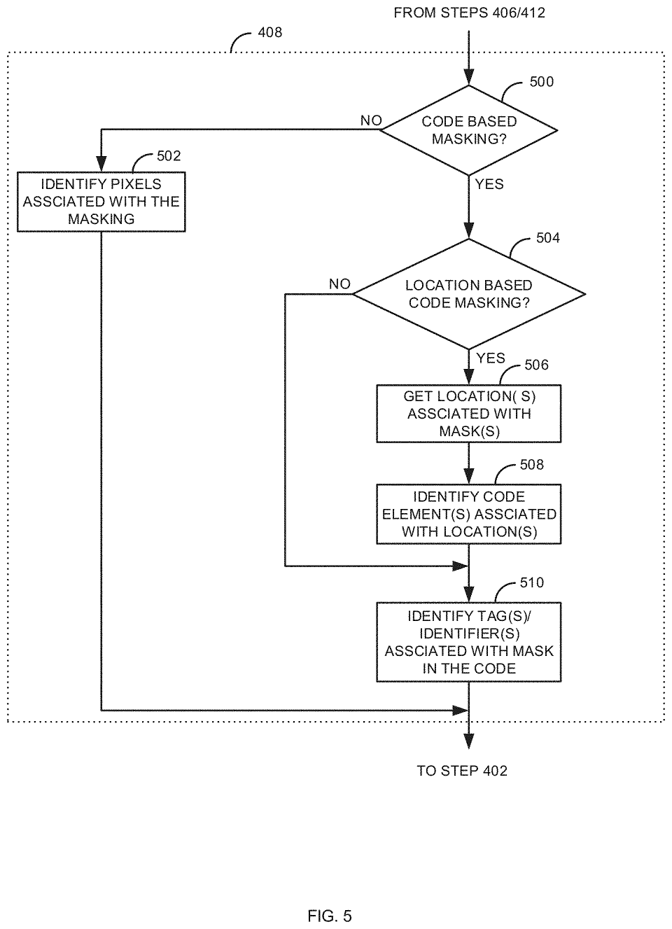

FIG. 5 is a flow diagram of a process for determining how object(s) 103 are masked in a communication session. FIG. 5 is an exemplary embodiment of step 408 of FIG. 4. Following step either step 406 or 412, the masking application 104/224 determines if the masking is code based masking in step 500. In code based masking, the masking application 104/224 looks at code (e.g., JavaScript, DOM, Hyper-Text Markup Language (HTML), Extended Markup Language (XML), etc.) that is used to display the window 300 of a co-browsing session to determine if one or more objects 103 are to be masked. If code based masking is not used in step 500, the masking application 104/224 identifies the pixels associated with the masking in step 502 and the process goes to step 402.

Otherwise, if code based masking is used in step 500, the masking application 104/224 determines, in step 504, if location based code masking is being used. Location based code masking is where the location of a mask area 312 is used to identify specific code objects 103 that are located/partially located in the mask area 312. For example, in FIG. 3 if the user masked out all of the data provided text field 310, based on location information in the JavaScript/DOM code (where the object 103 is displayed in the display 300), the masking application 104/224 can determine that the user has masked out the data provided text field 310. The masking application 104/224 changes the actual code of the data provided text field 310 (e.g., removes the text, deletes the object, changes a color of the object so that it cannot be seen, etc.) before it is transmitted to the other user communication devices 101 in the communication session. If location-based code masking is used in step 504, the masking application 104/224 gets the location(s) associated with the mask(s) in step 506. The masking application 104/224 identifies the code elements (e.g., a text object 103, an image object 103, a button that plays a .wav file, etc.) associated with the location(s) in step 508. For example, the masking application 104/224 may identify an image object 103 with an associated .wav file that is played when the image object 103 is displayed. The masking application 104/224 identifies, in step 510, the tag(s)/identifier(s) associated with the mask in the code. For example, the image object 103/.wav file 103 may have specific tags in the code that identify the image object 103/.wav file 103. The process then goes to step 402.

If location-based code masking is not being used in step 504, the masking application 104/224 identifies the tag(s)/identifier(s) associated with the mask in the code in step 510. For example, an administrator may define the tag(s)/identifier(s) via a graphical interface as a global object 103 (e.g., a code object 103 for a credit card number) that is always to be masked. The process then goes to step 402.

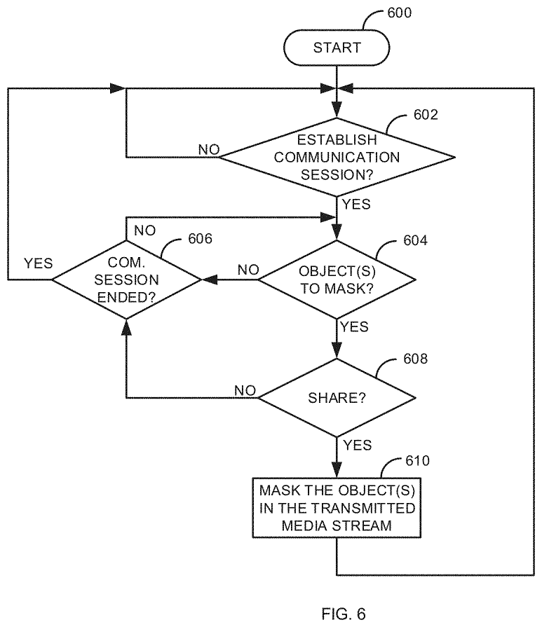

FIG. 6 is a flow diagram of a process for facilitating object masking in a communication session. The process starts in step 600. The communication manager 221 and/or user communication device 101 (e.g., in a peer-to-peer communication session) determines if the communication session is established in step 602. If the communication session has not been established in step 602, the process of step 602 repeats.

Otherwise, if the communication session has been established in step 602, the masking application 104/224 determines, in step 604, if there are any objects 103 to be masked. If there are not any object(s) 103 to be masked in step 604, the communication manager 221 and/or user communication device 101 determines, in step 606, if the communication session has ended. If the communication session has ended in step 606, the process goes back to step 602. Otherwise, if the communication session has not ended in step 606, the process goes back to step 604.

If there are object(s) 103 to be masked in step 604 (e.g., the user has masked a mask area 312 and/or an administrator has identified a code object 103), the masking application 104/224 determines, in step 608, if the user wants to share the window 300. If the user does not want to share the window 300 in step 608, the process goes to step 606. Otherwise, if the user wants to share the window 300, in step 608, the masking application 104/224 masks the object(s) 103 in the transmitted media stream. Masking the object(s) 103 in the transmitted media stream can happen in various ways. For example, the masking can occur where an image is sent (e.g., a live video session) and the masking occurs based on dynamic object recognition (e.g., facial recognition). The object 103 (e.g., a face) is then masked by changing pixels before being transmitted to the other users.

In another embodiment, where there is a co-browsing session, the actual code (e.g., JavaScript/DOM) in the controlling user's browser 102 is sent to the other user communication devices 101. The object(s) 103 are masked (e.g., by removing the object 103 from the code or clearing out or removing content of an image (or a portion of the image)) before the code is transmitted to the other user communication devices 101.

In another embodiment, where there is a co-co-browsing session, an image is rendered based on the masked code of the controlling user's browser 102. The rendered image (based on the masked code) is then transmitted to the other user communication devices 101.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIVI926EJS™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network 110, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
receive, during a communication session, a first request to mask a first object in a transmitted media stream of the communication session;
determine that the media stream is going to be transmitted in the communication session;
mask the first object from the media stream of the communication session; and
transmit the media stream of the communication session with the masked first object.

2. The system of claim 1, wherein the communication session is a co-browsing communication session and wherein determining that media stream is going to be transmitted in communication session further comprises determining that the first object is a first code object of a displayed browser view in the co-browsing session.

3. The system of claim 2, wherein the first request to mask the first object in the transmitted media stream of the communication session uses a location of the first masked object identify the first code object in code of the displayed browser view in the co-browsing session.

4. The system of claim 1, wherein the communication session is a co-browsing communication session and wherein the microprocessor readable and executable instructions further cause the microprocessor to:
receive a first user input to request control in the co-browsing session;
send a relinquish control message; and
receive a second user input to share a browser view in the co-browsing session.

5. The system of claim 1, wherein the communication session is with at least three users and wherein the microprocessor readable and executable instructions further cause the microprocessor to:
receive user input from a first user of the at least three users that identifies at least one other user of the at least three users, wherein the user input defines that the at least one other user will not have the first object masked from the media stream of the communication session.

6. The system of claim 1, wherein the first object is a first element in a first image object, wherein the first element in the first image object is identified based on a location relative to a second element in the first image object.

7. The system of claim 1, wherein the first object is a first image object and wherein masking the first image object from the media stream of the communication session comprises masking at least a portion of the first image object based on facial recognition.

8. The system of claim 1, wherein the first object is masked based on at least one of:
masking a number of pixels in a masked area in the transmitted media stream;
removing or changing the first object in a co-browsing session, wherein the first object is a code object that is transmitted as code in the transmitted media stream; and
removing or changing the first object in the co-browsing session, wherein the removed or changed first object is the code object that is rendered as an image in the co-browsing session before the media stream of the communication session is transmitted.

9. The system of claim 1, wherein the first object is a first global object and wherein the first global object is masked in multiple communication sessions based on one or more attributes associated with the first global object.

10. The system of claim 1, wherein the communication session is one of a peer-to-peer communication session or a communication server based communication session.

11. The system of claim 1, wherein the microprocessor readable and executable instructions further cause the microprocessor to:
receive user input from a first user to pause the transmitted media stream of the communication session to other users in the communication session;
receive a second request to mask a second object in the media stream of the communication session;
mask the second object from the media steam of the communication session; and
transmit the media stream of the communication session with the masked second object.

12. A method comprising:
receiving, during a communication session, a first request to mask a first object in a transmitted media stream of the communication session;
determining that the media stream is going to be transmitted in the communication session;
masking the first object from the media stream of the communication session; and
transmitting the media stream of the communication session with the masked first object.

13. The method of claim 12, wherein the communication session is a co-browsing communication session and wherein determining that media stream is going to be transmitted in communication session further comprises determining that the first object is a first code object of a displayed browser view in the co-browsing session.

14. The method of claim 13, wherein the first request to mask the first object in the transmitted media stream of the communication session uses a location of the first masked object identify the first code object in code of the displayed browser view in the co-browsing session.

15. The method of claim 12, wherein the communication session is with at least three users and further comprising:
receiving user input from a first user of the at least three users that identifies at least one other user of the at least three users, wherein the user input defines that the at least one other user will not have the first object masked from the media stream of the communication session.

16. The method of claim 12, wherein the first object is a first element in a first image object, wherein the first element in the first image object is identified based on a location relative to a second element in the first image object.

17. The method of claim 12, wherein the first object is a first image object and wherein masking the first image object from the media stream of the communication session comprises masking at least a portion of the first image object based on facial recognition.

18. The system of claim 12, wherein the first object is masked based on at least one of:
masking a number of pixels in a masked area in the transmitted media stream;
removing or changing the first object in a co-browsing session, wherein the first object is a code object that is transmitted as code in the transmitted media stream; and
removing or changing the first object in the co-browsing session, wherein the removed or changed first object is the code object that is rendered as an image in the co-browsing session before the media stream of the communication session is transmitted.

19. The method of claim 12, wherein the first object is a first global object and wherein the first global object is masked in multiple communication sessions based on one or more attributes associated with the first global object.

20. A non-transient computer readable medium having stored thereon instructions that cause a microprocessor to execute a method, the method comprising:
instructions to receive, during a communication session, a first request to mask a first object in a transmitted media stream of the communication session;
instructions to determine that the media stream is going to be transmitted in the communication session;
instructions to mask the first object from the media stream of the communication session; and
instructions to transmit the media stream of the communication session with the masked first object.
